(19) United States
(12) Patent Application Publication
(10) Pub. No.: US 2012/0011229 A1
(43) Pub. Date: Jan. 12, 2012

(54) ENHANCED NETWORK/DOMAIN NAME HASHING TECHNIQUES

(76) Inventors: Peter HELLER, Somerville, MA (US); Vladimir OKSMAN, Morganville, NJ (US); Patrick KELLIHER, Chelmsford, MA (US)

(21) Appl. No.: 13/151,143

(22) Filed: Jun. 1, 2011

Related U.S. Application Data
(60) Provisional application No. 61/351,820, filed on Jun. 4, 2010.

(51) Int. Cl. G06F 15/177

(52) U.S. Cl. 709/220

(57) ABSTRACT

Described herein are techniques related to a generation of a short identifier of a domain/network that is based upon the long human-readable network/domain name (NDN) that a user or admin typically gives to the network/domain. With one or more implementations described herein, the short network/domain identifier (DNI) is based upon a version of the long human-readable NDN that has been modified to remove any data that is superfluous to distinguishing the NDN for any other. This Abstract is submitted with the understanding that it will not be used to interpret or limit the scope or meaning of the claims.

### RELATED APPLICATION

This application claims the benefit of priority to U.S. Provisional Patent Application Ser. No. 61/351,820, filed on Jun. 4, 2010, the disclosure of which is incorporated by reference herein.

### BACKGROUND

It is a general practice that each domain of the network or the network itself is assigned a name. This name is typically called a Network Name or Domain Name. This name is usually assigned by the user/admin during installation of the network or domain. To avoid confusion with neighboring and linked networks/domains, it is desirable that the assigned name be unique. By using a unique name, a new device/node that joins the network/domain can identify the network/domain that the device/node intends to join from other neighboring networks/domains or those sharing the medium. A popular example of such network names is a well-known Service Set Identification (SSID) which identifies an IEEE 802.11-based Wireless Local Area Network (WLAN). A SSID is a 32-byte network name assigned by the user/admin so that his/her devices when connecting to the network may identify the network that they intend to join.

Typically, networking standards reserve more than sufficient room (like 32 bytes of the SSID) to provide ample opportunity to make the Network/Domain Name (NDN) unique relative to the neighboring, linked, or otherwise associated networks/domains. Also, typically, networking standards define a NDN in a human-readable format, such as alphanumeric character encoded in an ASCII (American Standard Code for Information Interchange) format. For example, a user may use “JillHouse” as the SSID of their WLAN.

To assist new devices in joining the right network, a conventional network controller broadcasts the NDN from time to time, so that joining devices can receive it. Unfortunately, since the NDN is long (to be unique and accommodate human-readability) and since the NDN is frequently broadcast, the transmission of NDN takes a significant amount of time on the medium. That is, the frequent rebroadcasting of the long NDN consumes a significant amount of the available bandwidth of a network.

To address this issue, some approaches use a short machine-readable identifier in place of the long human-readable NDN. For example, a family of networking standard called G.hn has been proposed by the International Telecommunication Union's Standardization arm (ITU-T) and promoted by the HomeGrid Forum. The G.hn specifications define networking over both wireline (e.g., power lines, phone lines and coaxial cables) and wireless networks.

The G.hn specification designated G.9961 specifies the data link layer (DLL) for wireline and wireless based home networking transceivers capable of operating over premises wiring including inside telephone wiring, coaxial cable, and power-line wiring. It complements the system architecture and physical layer (PHY) specification in the G.hn specification designated G.9960.

The G.9961 specification describes a so-called “Domain Name Identifier” (DNI), which is a short machine-readable identifier transmitted each MAC (Media Access Control) cycle. While some NDNs (such as the SSID) are 32-bytes long, the DNI of G.hn is 2-bytes long. Consequently, the repeated transmission of the DNI does not impact the network bandwidth as much as frequent rebroadcasts of the NDN (like the SSID of the 802.11 standards) do. Indeed, with G.hn, the full NDN is rarely transmitted.

Since the DNI is short, the chances of an adjacent (e.g., neighboring, linked, media-sharing, and/or associated) network or domain having the same name is greatly increased. So, the DNI is used as a preliminary determination of whether to proceed with the joining of a network.

According to the G.hn specification, a new device wishing to join a network first looks at the DNI. The new device determines whether the DNI appears to be a result of a proper hashing of the desired NDN. If so, then the DNI appears that DNI seems to fit and, thus, the new device continues the process of joining until the network controller eventually transmits NDN. Then the joining device makes the final verification. This verification is needed because hashing of the NDN into DNI may result in two different NDN being hashed into the same DNI value.

While the G.hn specification introduces the DNI and describes how it might be used, the specification fails to recommend a particular hashing procedure that may be employed. With the proper hashing procedure, both the network controller and the joining device may hash the NDN independently to get the same DNI. On the other hand, the hashing of two different NDNs (thus different networks) should have a very low probability of getting the same DNI. No hashing procedure is currently defined by the G.hn specification and existing hashing procedures do not take in account the specifics of the NDN format.

### SUMMARY

Described herein are techniques related to a generation of a short identifier of a domain/network that is based upon the long human-readable network/domain name (NDN) that a user or admin typically gives to the network/domain. With one or more implementations described herein, the short network/domain identifier (DNI) is based upon a version of the long human-readable NDN that has been modified to remove any data that is superfluous to distinguishing the NDN for any other.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an exemplary networking communications arrangement in which one or more implementations of the techniques described herein may be employed.

FIG. 2 illustrates an exemplary transmitter apparatus configured to implement the techniques described herein.

FIG. 3 illustrates an exemplary network device configured to implement the techniques described herein.

FIG. 4 is a flowchart of a process that is configured to implement the techniques described herein.

FIG. 5 illustrates a diagram of a Network/Domain Name (NDN), which is the basis upon which implementations of the techniques described herein operate.

FIGS. 6 and 7 are flowcharts of processes that are configured to implement the techniques described herein for sticky messaging.

The Detailed Description references the accompanying figures. In the figures, the left-most digit(s) of a reference number identifies the figure in which the reference number first appears. The same numbers are used throughout the drawings to reference like features and components. Also, note that any text smaller than ten point is presented merely to indict where text would appear in the depicted figures. Since such text is merely an indicator of where text might appear, the content of such text is unimportant to the understanding the implementations depicted.

### DETAILED DESCRIPTION

Described herein are techniques related to a generation of a short identifier of a domain/network that is based upon the long human-readable network/domain name (NDN) that a user or admin typically gives to the network/domain. With one or more implementations described herein, the short network/domain identifier (DNI) is based upon a modified version of the long human-readable NDN. The NDN is modified by removing superfluous portions of the NDN. The NDN is designed to be human-readable and it is long enough to allow the user/admin to create a memorable and unique name for the domain/network. Unfortunately, much of the long space reserved for the human-readable name is often left unused. Also, the human-readable format (such as ASCII) of the NDN is typically inefficient.

With one or more implementations described herein, the NDN is modified to remove the unused, unnecessary, inefficient, and ignored portions of the NDN. These portions are not necessary and not used to distinguish one network from another by their NDNs. From this modified NDN, the DNI is generated from a hash function.

This short DNI is rebroadcast by a network controller to advertise itself to inquisitive devices seeking to join a domain/network. Indeed, the DNI may be rebroadcast every MAC cycle. The repeated broadcast of the DNI (e.g., about 2-bytes long) consumes significantly less bandwidth than the rebroadcast of the conventional NDN (e.g., about 32-bytes long). Once an inquisitive device identifies and maps to the desired or expected NDN, the device begins the process of joining the domain/network with the NDN name. Since the DNI can map onto multiple NDN, the device waits for an occasional broadcast of the NDN to confirm the joining of that domain/network.

### Exemplary Network Communications Arrangement

An exemplary communication arrangement may employ at least two multicarrier apparatuses or nodes. The exemplary communication arrangement may also employ a multicarrier controller apparatus or controller node. In one implementation, the multicarrier apparatuses/controller are Orthogonal Frequency Division Multiplexing (OFDM) apparatuses capable of implementing the herein described techniques. In another implementation, the exemplary communication arrangement employs apparatuses or nodes that communicate via a wireless/wireless medium by way of one or more communication protocols.

The multicarrier apparatuses may communicate through a communication channel. The communication channel may be realized as one or more wireless communication media, one or more wireline communication media (e.g., coaxial cable, twisted pair of copper wires, power line wiring, Ethernet cabling, optical fiber, etc.), or combinations thereof. Accordingly, the multicarrier apparatuses may include structure and functionality that enable signal communication over such media. Such structure and functionality may include one or more antennas, integrated wireline interfaces, and the like. Such structure and functionality may employ multiple differing wireline media (e.g., coaxial cable and power line wiring). Depending on the implementation, the multicarrier apparatuses may communicate with one another directly (peer-to-peer mode) or the multicarrier apparatuses may communicate via the controller apparatus. The G.hn recommendations specify standards by which multicarrier apparatuses may communicate via such communications channels.

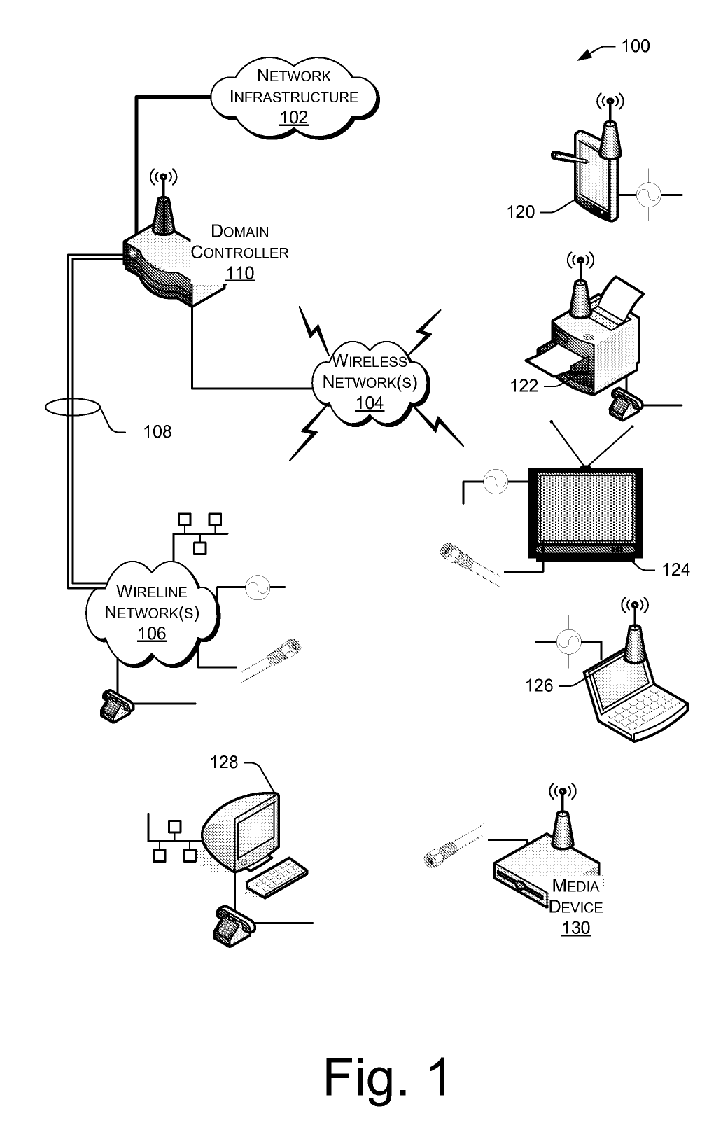

FIG. 1 shows an exemplary networking communications arrangement 100 in which one or more implementations may be employed. The multicarrier controller apparatus of the arrangement 100 is an access point 110 of a home networking environment. As shown in FIG. 1, the access point 110 may be a residential gateway that distributes broadband services from a connected network infrastructure 102 (e.g., the Internet) to various multicarrier apparatuses via one or more wireless networks 104 and one or more wireline networks 106. The wireless networks 104 may also be called wireless local area networks (WLAN) and the wireline networks 106 may be called local area networks (LANs).

The various multicarrier apparatuses depicted in FIG. 1 include a tablet computer 120, a network printer 122, a television 124, a laptop computer 126, a desktop computer 128, and a media device 130 (e.g., a digital video recorder (DVR) and Internet TV device). The multicarrier apparatuses may be associated with digital content destinations in the home, but may also be associated with digital content sources, such as digital video recorders (DVR), computers providing streaming video, televisions, entertainment centers, and the like.

As depicted, the tablet computer 120 is configured to communicate via both wireless and a power-line wireline networks, the network printer 122 is configured to communicate via both wireless and twisted-pair cabling (e.g., telephone wiring) based wireline networks, the television 124 is configured to communicate via both two different wireline networks (e.g., coaxial cabling and power-line cabling based), the laptop computer 126 communicates via power-line based wireline and wireless networks, and the desktop computer 128 is configured to communicate via an Ethernet cabling based wireline network and twisted-pair cabling (e.g., telephone wiring) based wireline networks. Similarly, the media device 130 is configured to communicate via both wireless and coaxial cabling (e.g., cable TV wiring) based wireline networks. As depicted, the wireline networks 106 include wireline networks based upon Ethernet cabling (e.g., Cat-5), power-line wiring, coaxial cabling, and telephone cabling. As represented by multiple wire connection 108, the domain controller 110 is connected via multiple different wirings to the multiple different wireline networks 106.

Furthermore, the multicarrier apparatuses may be enabled to communicate using packet-based technology (e.g., ITU G.hn, HomePNA, HomePlug® AV and Multimedia over Coax Alliance (MoCA)) and xDSL technology). Such xDSL technology may include Asymmetric Digital Subscriber Line (ADSL), ADSL2, ADSL2+, Very high speed DSL (VDSL), VDSL2, G.Lite, and High bit-rate Digital Subscriber Line (HDSL). In addition, some multicarrier apparatuses (such as 120, 122, 126, and 130) may be enabled to communicate using IEEE 802.11 and IEEE 802.16 (WiMAX) wireless technologies.

Signals exchanged between the multicarrier apparatuses may include multicarrier symbols that each includes a plurality of tones or sub-channels. Each of the tones within a multicarrier symbol may have data bits modulated thereon that are intended for delivery from one of the multicarrier apparatuses to another.

### Exemplary Multicarrier Apparatus

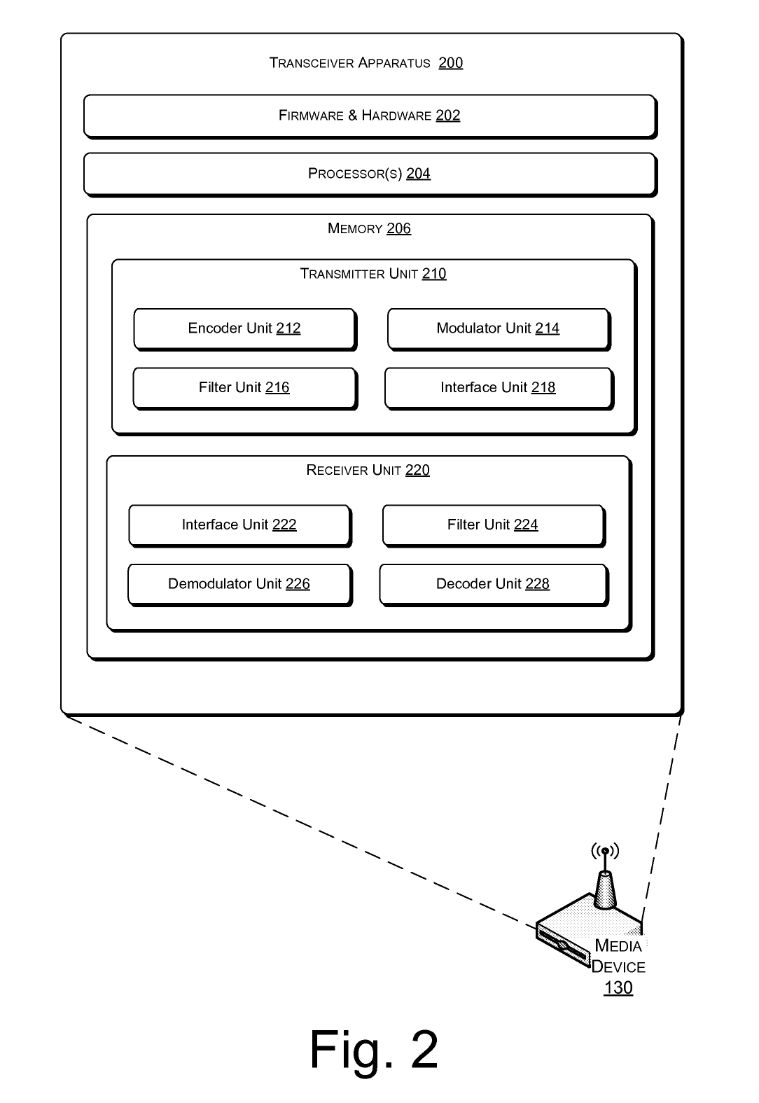

FIG. 2 shows an exemplary multicarrier apparatus configured to implement the techniques described herein. As depicted, the exemplary multicarrier apparatus is the media device 130 introduced in FIG. 1. Alternatively, other multicarrier apparatus introduced in FIG. 1 may be been depicted here. Furthermore, the multicarrier controller apparatus (which is the access point 110 in FIG. 1) may be been depicted here as well. While the functions and duties of the multicarrier controller apparatus differ from the functions and duties of the multicarrier apparatuses, their functionalities overlap with regard to generating a DNI from a NDN and basic handing of the results.

The media device 130 shown in FIG. 2 is an example of a transceiver apparatus 200 that may be used as a transmitting and receiving apparatus in a multicarrier arrangement, like arrangement 100 shown in FIG. 1. The transceiver apparatus 200 may include firmware & hardware 202, one or more processors 204, and a memory 206. The transceiver apparatus 200 has one or more modules of processor-executable instructions stored in the memory 206. The transceiver apparatus 200 may include a module called a transmitter unit 210. The transmitter unit 210 may include several sub-modules, such as an encoder unit 212, a modulator unit 214, a filter unit 216, and an interface unit 218.

The encoder unit 212 may be capable of receiving data that is for communication to a receiving device coupled to the transceiver apparatus via a wireless or wireline medium. More specifically, the encoder unit 212 may be capable of translating incoming data bit streams into in-phase and quadrature components for each of the plurality of tones. The encoder unit 212 may be arranged to output a number of symbol sequences that are equal to the number of tones available to the system.

The modulator unit 214 may be capable of receiving symbol sequences to produce a modulated signal in the form of a discrete multi-tone signal. The modulator unit 214 may pass the modulated signal to the filter unit 216 to undergo various filtering. Then the filtered signal may be passed to the interface unit 218 for communication over the medium to a receiving device.

The transceiver apparatus may also include a receiver unit 220 that is capable of receiving modulated multi-tone signals communicated over the medium from a transmitting device. The receiver unit 220 may include an interface unit 222, a filter unit 224, a demodulator unit 226, and a decoder unit 228.

Signals received by the receiver unit 220 may be passed to the filter unit 224 via the interface unit 222. After received signals undergo filtering by way of the filter unit 224, the filtered signals may be demodulated by the demodulator unit 226. The demodulated signals may be passed to and processed by the decoder unit 228. The decoder unit 228 produces data bit streams for consumption by a computing device, or the like. Effectively, the demodulator unit 226 and the decoder unit 228 perform the opposite functions of the modulator unit 214 and the encoder unit 212, respectively.

While the transceiver apparatus 200 is described herein in terms of modules and sub-modules of processor-executable instructions, the functionalities of these modules and sub-modules may be implemented in software, hardware, firmware, or some combination thereof.

For example, the transceiver apparatus 200 may have a hardware component called a controller. The terms “controller” and “processor” include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

Of course, each of the transmitter unit 210 and the receiver unit 220 may have one or more of its own dedicated controllers or processors. Alternatively, each unit may share one or more common controllers or processors.

### Exemplary Network Device Employing Enhanced Network/Domain Name Hashing Techniques

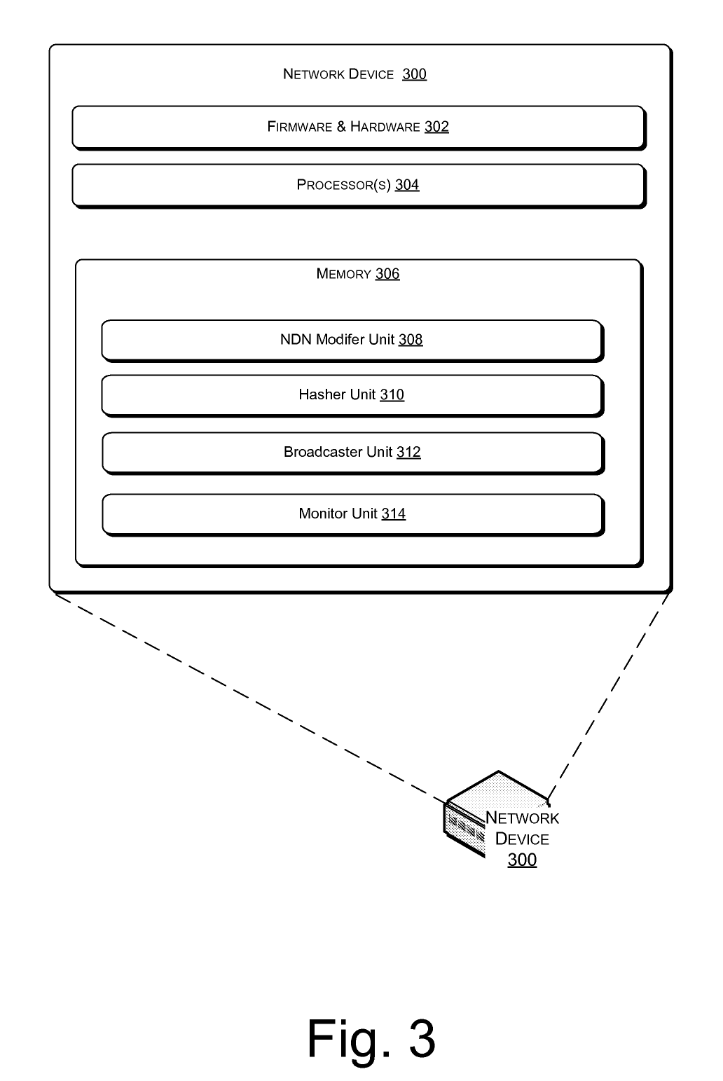

FIG. 3 shows an exemplary network device 300 configured to employ the enhanced network/domain name hashing techniques described herein. The network device 300 may be a network controller, a multicarrier controller apparatus (such as the access point 110 in FIG. 1), a multicarrier apparatus (such as 120-130 of FIG. 1), and/or it might be the transceiver apparatus 200 of FIG. 2.

The network device 300 is depicted, in FIG. 3, in an expanded view to better show some of the relevant component therein. The network device 300 may include firmware & hardware 302, one or more processors 304, and a memory 306. The network device 300 has one or more modules of processor-executable instructions stored in the memory 306. The network device 300 may include a network/domain name (NDN) modifier unit 308, hasher unit 310, broadcaster unit 312, and monitor unit 314.

The NDN modifier unit 308 obtains the NDN, such as the SSID of WLANs based upon IEEE 802.11 standards. The NDN modifier unit 308 modifies the NDN to remove any data that is superfluous to the purpose of effectively distinguishing one network/domain from another. In other words, the data remaining in the modified NDN is only that which is effective in identifying the network/domain and potentially distinguishing it from any others. The modified NDN includes a condensed or concatenation of the remaining non-superfluous data.

The hasher unit 310 selects a hashing key. That hashing key is used by the hashing function to determine the Domain/Name Identifier (DNI) from the modified NDN. The hasher unit 310 calculates a hash value based upon the modified NDN and the hashing key. The calculated hash value is the DNI.

The broadcaster unit 312 broadcasts the DNI and the hashing key. They may be broadcast concurrently or at differing intervals and cycles. The network device that typically broadcasts the DNI and hashing key is a network controller (such as access point 110 of FIG. 1). Also, the broadcaster 312 occasionally broadcasts the NDN with the hash key incorporated in the unused portions of the NDN.

The monitor unit 314 monitors the DNI of other networks/domains. If it detects another network/domain with a duplicate DNI, the monitor unit 314 takes actions to correct the matter. Such actions may include generating a new DNI based upon a new hashing key.

While the network device 300 is described herein in terms of modules and sub-modules of processor-executable instructions, the functionalities of these modules and sub-modules may be implemented in software, hardware, firmware, or a combination thereof.

### Exemplary Processes

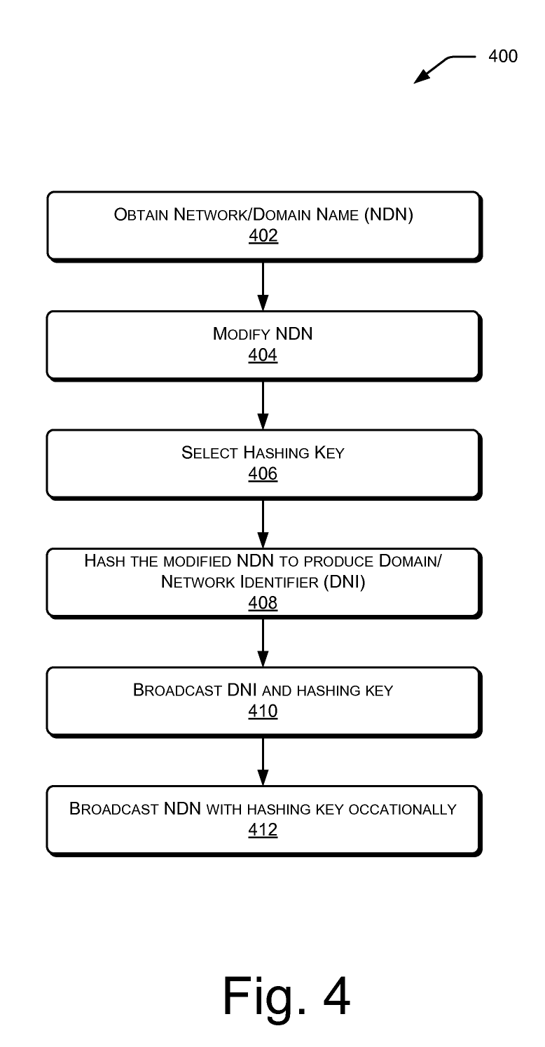

FIGS. 4, 6, and 7 are flowcharts illustrating exemplary processes 400, 600, and 700 that implement the techniques described herein for generating and handling a DNI. The exemplary processes 400, 600, and 700 are performed, at least in part, by a networking device such as a multicarrier controller apparatus (e.g., the access point 110 of FIG. 1) and/or a multicarrier apparatus (e.g., the media device 130 of FIGS. 1 and 2). Many of the operations of the processes 400, 600, and 700 are described with references to the illustration of such operations in previously introduced drawing figures, such as FIGS. 1 and 2.

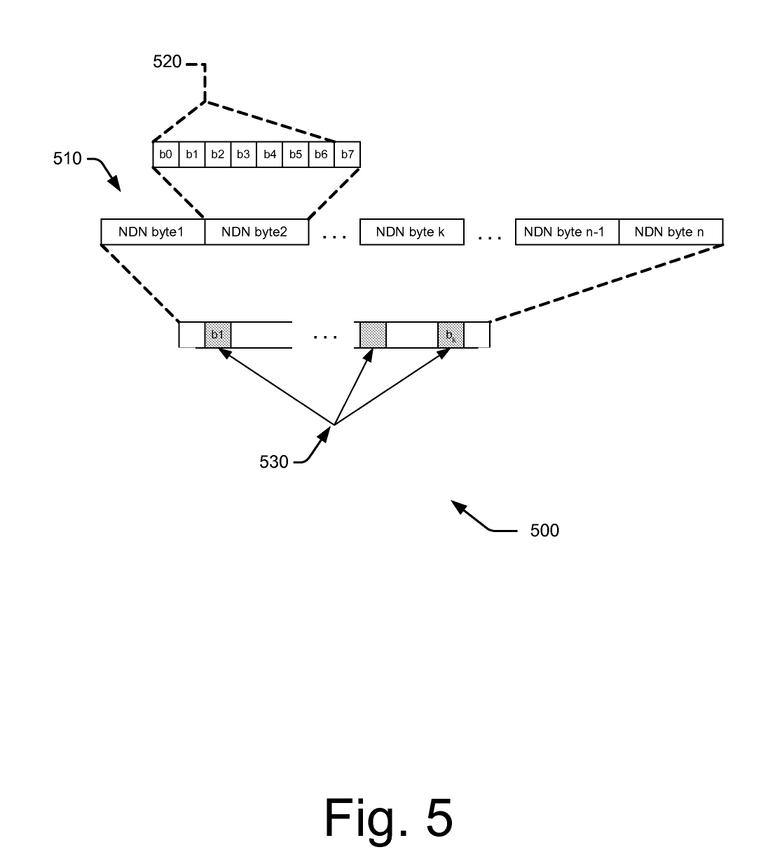

FIG. 4 includes process 400, which illustrates techniques for generating a DNI from an NDN. The operations of process 400 are described with reference to the diagram 500 shown in FIG. 5.

At 402, the process 400 begins with a network device obtaining a network/domain name (NDN) 510, such as the SSID of WLANs based upon IEEE 802.11 standards. Since the NDN 510 is typically generated by a user/admin and is intended to identify a specific domain or network, the NDN 510 contains human-readable alphanumeric characters. More precisely, the NDN 510 is often based upon the ASCII character set.

As shown in FIG. 5, the NDN 510 is n bytes long. SSID, for example, is 32 bytes long. So, n is 32 for the SSID. The NDN 510 of other standards may differ in the value of n.

At 404, the network device modifies the NDN 510 to remove any data that is superfluous to the purpose of effectively distinguishing one network/domain from another. In other words, the data remaining in the modified NDN 510 is only that which is effective in identifying the network/domain and potentially distinguishing it from any others. More generally, this may be described as eliminating at least a portion of the NDN.

Since the NDN 510 is long enough to produce a distinguishing name, but one that is recognizable and memorable to a human, the length n of the NDN is often much longer than the length of the name used in practice. For example, the actual length of the SSID is usually much shorter than the 32 characters allowed.

To take advantage of this fact about the NDN, the NDN modification operation 404 removes the leading string of useless characters before the actual text used for the NDN. This string is typically formed from NULL (unused), spaces, and other invalid ASCII codes that represent non-letters and non-digits. Some of the popular symbols (e.g., & or @) may be retained. Any other characters that are not expressly allowed to be a part of a user-created NDN may also be removed.

In addition, the first bit of each byte is removed. Byte 520 has, of course, eight bits (b0 . . . b7). However, the ASCII code is a seven bit code. The first bit of each byte (e.g., b7 of byte 520) carrying an ASCII character is always zero. Therefore, the first bit of each byte (e.g., b7 of byte 520) of the NDN is superfluous and thus can be removed without any loss. Then, in operation 404, the remaining bits of the remaining bytes may be concatenated to form the modified NDN, which may also be called the codeword herein.

At 406, the network device selects a hashing key. That hashing key is used by the hashing function to determine the Domain/Name Identifier (DNI) from the modified NDN. The nature of the hashing key depends upon the specific hashing function employed. The key may be a value that designates an offset amount designating where the bits of the DNI would be selected from the modified NDN. Alternatively, the key may be a polynomial G. The hashing key may be selected from a look-up table in memory. Alternatively, the hashing key is calculated. Alternatively still, the hashing key may be randomly generated. Of course, some combination of any of the three approaches may be employed to select the hashing key.

At 408, the network device calculates a hash value based upon the modified NDN and the hashing key. The calculated hash value is the DNI. With one or more implementations, the modified NDN is hashed by picking T bits from the modified NDN. T may be the length of the DNI and a hashing key m determines which bits are picked from the modified NDN.

With such a hash, every m-th bit of the bit string of the modified NDN is picked, starting from the beginning of the string and wrapping around if the number of collected bits when reaching the end of the string is less than required for DNI. The hashing key will be the value of m or a value associated with m.

In another embodiment, this hashing may divide the bit string by a key-polynomial G and take the T-bit remainder, such as is usually done for generating cyclic-redundancy check (CRC). In this case, the hashing key is the polynomial G.

Of course, other variations and forms of hashing may be employed. And other keys may be used. Regardless of the specific hashing approach used, the DNI is derived from the modified NDN.

At 410, the network device broadcasts the DNI and the hashing key. They may be broadcast concurrently or at differing intervals and cycles. The network device that typically broadcasts the DNI and hashing key is a network controller (such as access point 110 of FIG. 1). For example, in case the key is to take every m-th bit from the modified NDN, the broadcasted value of the key is equal to m.

At 412, the network device occasionally broadcasts the NDN with the hash key incorporated in the unused portions of the NDN. In case the key is a polynomial, the coefficients of the polynomial may be occasionally communicated using b7 of the NDN bytes when the NDN is broadcast in full. Indeed, FIG. 5 shows the coefficients being inserted into the NDN 510 using the unused bits (b7) of the NDN bytes.

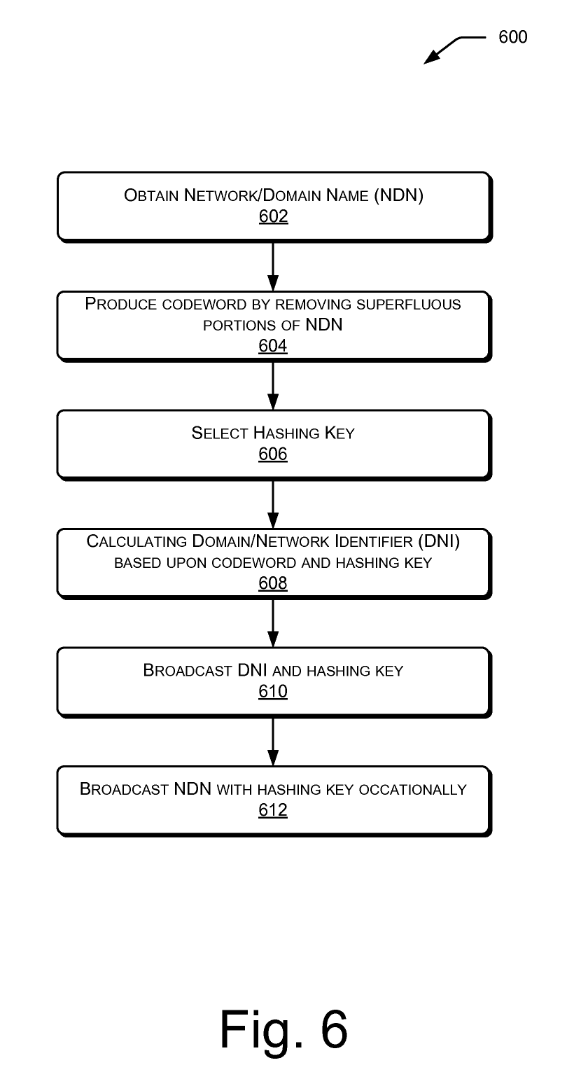

FIG. 6 shows process 600, which illustrates techniques for generating a DNI from an NDN—particularly, when the NDN is 32-bytes long (like the SSID is) and the DNI is 16-bits long. Process 600 uses a hashing key that takes every m-th bit of the bit string of a modified NDN.

At 602, the process 600 begins with a network device (such as a domain master) obtaining a network/domain name (NDN), such as the SSID of WLANs based upon IEEE 802.11 standards. Since the NDN is typically generated by a user/admin and is intended to identify a specific domain or network, the NDN contains human-readable alphanumeric characters. More precisely, the NDN is often based upon the ASCII character set.

At 604, the network device modifies the NDN to remove any data that is superfluous to the purpose of effectively distinguishing one network/domain from another. In other words, the data remaining in the modified NDN is only that which is effective in identifying the network/domain and potentially distinguishing it from any others.

More particularly, the network device examines the bytes of the NDN sequentially from the first to the last one. All bytes with a hexadecimal value less than 4016 may be removed. The remaining bytes of the NDN may be concatenated into a single codeword in the order that they are in the original NDN. That single codeword may also be called the modified NDN. Prior to concatenation, the most significant bit of each byte may be removed (because the most significant bit of an ASCII-coded byte is not used). The valid length of this codeword is 7 to 224 bits. The first bit of the codeword is the least significant bit of the NDN bytes of the lowest order that is a member of the codeword.

At 606, the network device selects a hashing key. That hashing key is used by the hashing function to determine the Domain/Name Identifier (DNI) from the modified NDN. The nature of the hashing key depends upon the specific hashing function employed. The key may be a value that designates an offset amount designating where the bits of the DNI would be selected from the modified NDN. Alternatively, the key may be a polynomial G. The hashing key may be selected from a look-up table in memory. Alternatively, the hashing key is calculated. Alternatively still, the hashing key may be randomly generated. Of course, some combination of any of the three approaches may be employed to select the hashing key.

At 608, the network device calculates a hash value based upon the codeword and the hashing key. The calculated hash value is the DNI. With one or more implementations, the codeword is hashed by picking each m-th bit of the codeword, where m is a hashing key. The picking starts with the first bit and moves though the codeword from there. The picking may stop when the number of collected bits is 16, which is the length of the DNI. If less than 16 bits are collected when the end of the codeword is reached, the picking wraps around to the beginning of the codeword. Alternatively, a cyclic-redundancy check (CRC) of the codeword with a 16-degree generating polynomial G(x) can be used to generate 16-bit DNI.

At 610, the network device broadcasts the DNI and the hashing key. They may be broadcast concurrently or at differing intervals and cycles. The network device that typically broadcast the DNI and hashing key is a network controller (such as access point 110 of FIG. 1). For example, in case the key is to take every m-th bit from the codeword, the broadcasted value of the key is equal to m. alternatively, a pre-defined set of hash-keys is standardized and the index of the hash-key is attached to the DNI.

Broadcasting the hashing key together with the NDN allows the network controller to change the DNI in case a network with the same DNI is eventually detected. This increases the robustness of the service. Process 700 describes what may occur when a network with the same DNI is detected.

At 612, the network device broadcasts the NDN with the coefficients of the polynomial incorporated into the most significant bit of the NDN bytes (since that bit is otherwise unused).

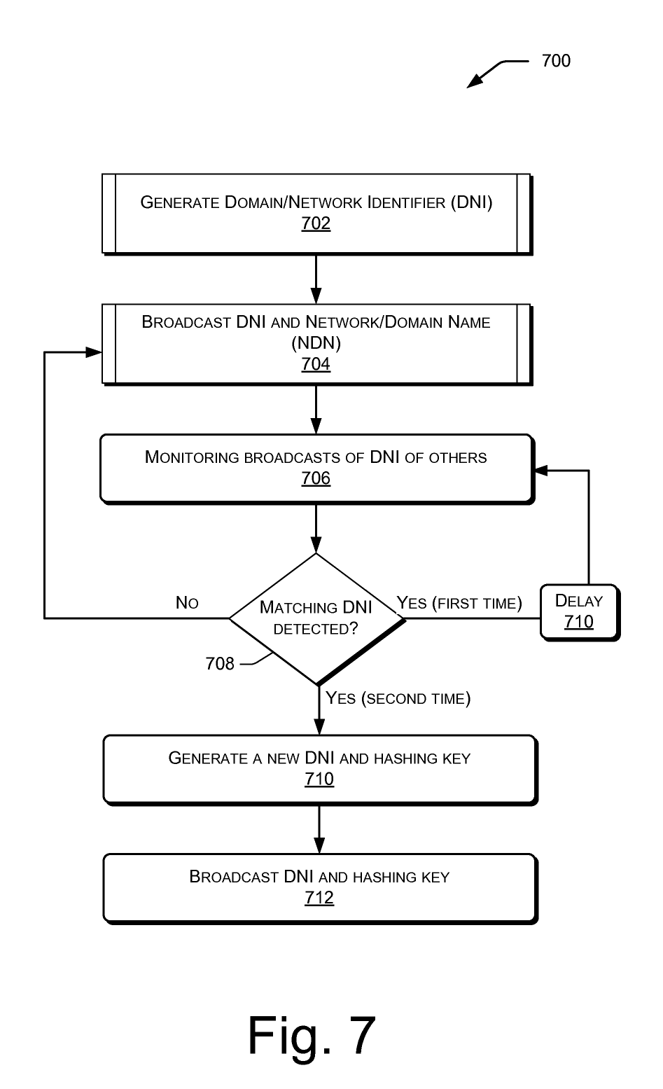

FIG. 7 shows process 700, which illustrates techniques for how a network controller handles a situation where another network/domain is detected using a duplicate DNI.

At 702, the process 700 begins with generating the DNI. This operation is a combination of operations 402-308 of FIG. 4 and/or operations 602-508 of FIG. 6.

Next, at 704, the network controller broadcasts the DNI and occasionally broadcasts the NDN. This operation includes operations 410 and/or 412 of FIG. 4 and/or operations 610 and/or 612 of FIG. 6.

At 706, the network controller monitors broadcasts from other domains/networks and listens for their DNI. These other domains/networks may be a neighboring, linked, associated, etc. domain/network. These other domains/networks may share one or more common wireline or wireless media. Alternatively, the network controller may receive a notification of the DNI of other domains/networks for other networked devices.

At 708, the network controller determines whether its own DNI matches the DNI of the other domains/networks. That is, it determines whether the other domains/networks are using a duplicate DNI. If not, then the process returns to the broadcast operation 704 and/or to the monitor operation at 706.

If the other DNI is a duplicate, then the first time that this is determined to be so for a specific domain/network, the network controller waits for a specified and/or random amount of time at 710. Typically, this delay may be several seconds. After this delay, the process returns to the monitor operation 706 and after receiving the DNI again the process moves to operation 708 to determine whether the other DNI has changed or whether it remains the same.

If the other DNI has changed, then this network controller does not need to change its DNI because the other domain/network has already changed theirs. Thus, a conflict no longer exists. Otherwise, if the other DNI remains unchanged and the conflict remains, the process proceeds to 710.

At 710, the network controller generates a new DNI and uses a new hashing key. This operation is much like operations 406 and 408 of FIG. 4 and/or operations 606 and 608 of FIG. 6. However, with this operation 710, a different hashing key is used to generate a new and different DNI.

At 712, the updated DNI and hashing key are broadcast. Consequently, new joining nodes will use the new DNI and hashing key to join the domain/network controlled by the network controller.

### Additional and Alternative Implementation Notes

Exemplary implementations discussed herein may have various components collocated; however, it is to be appreciated that the various components of the arrangement may be located at distant portions of a distributed network, such as a communications network and/or the Internet, or within a dedicated secure, unsecured and/or encrypted arrangement. Thus, it should be appreciated that the components of the arrangements may be combined into one or more apparatuses, such as a modem, or collocated on a particular node of a distributed network, such as a telecommunications network. Moreover, it should be understood that the components of the described arrangements may be arranged at any location within a distributed network without affecting the operation of the arrangements. For example, the various components can be located in a Central Office modem (CO, ATU-C, VTU-O), a Customer Premises modem (CPE, ATU-R, VTU-R), an xDSL management device, or some combination thereof. Similarly, one or more functional portions of the arrangement may be distributed between a modem and an associated computing device.

The above-described arrangements, apparatuses and methods may be implemented in firmware, hardware, software, one or more software modules, one or more software and/or hardware testing modules, one or more telecommunications test devices, one or more DSL modems, one or more ADSL modems, one or more xDSL modems, one or more VDSL modems, one or more linecards, one or more G.hn transceivers, one or more MOCA transceivers, one or more Homeplug transceivers, one or more powerline modems, one or more wired or wireless modems, test equipment, one or more multicarrier transceivers, one or more wired and/or wireless wide/local area network systems, one or more satellite communication systems, network-based communication systems (such as an IP, Ethernet or ATM system), one or more modems equipped with diagnostic capabilities, or the like, or on one or more separate programmed general purpose computers having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug or the like.

Additionally, the arrangements, procedures and protocols of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed procedures may be readily implemented in software using object or object-oriented software development environments that provide portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed procedures may be readily implemented in software that can be stored on a computer-readable storage medium, executed on a programmed general-purpose computer with the cooperation of a controller and memory, a special purpose computer, a microprocessor, or the like. In these instances, the arrangements and procedures of the described implementations may be implemented as a program embedded on a personal computer such as an applet, JAVA® or CGI script, as a resource residing on a server or computer workstation, as a routine embedded in a dedicated communication arrangement or arrangement component, or the like. The arrangements may also be implemented by physically incorporating the arrangements and/or procedures into a software and/or hardware system, such as the hardware and software systems of a test/modeling device.

The implementations herein are described in terms of exemplary embodiments. However, it should be appreciated that individual aspects of the implantations may be separately claimed and one or more of the features of the various embodiments may be combined. In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein are illustrated as a collection of blocks in a logical flow graph, which represents a sequence of operations that can be implemented with hardware, software, firmware, or some combination thereof. In the context of software/firmware, the blocks represent instructions stored on one or more processor-readable storage media that, when executed by one or more processors, perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “processor-readable media” includes processor-storage media. For example, processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

For the purposes of this disclosure and the claims that follow, the terms “coupled” and “connected” may have been used to describe how various elements interface. Such described interfacing of various elements may be either direct or indirect.

What is claimed is:

1. A network device comprising:
a network/domain name (NDN) modifier unit configured to obtain the NDN of a network/domain and produce a modified NDN that includes only non-superfluous data therein;
a hasher unit configured to hash the modified NDN to produce a Domain/Network Identifier (DNI).

2. A network device as recited in claim 1, further comprising a broadcaster unit configured to broadcast the DNI.

3. A network device as recited in claim 1, the hasher unit being further configured to select a hashing key, wherein the DNI is based upon a hash using the modified NDN and the hashing key.

4. A network device as recited in claim 3, the hasher unit being still further configured to produce the DNI by, at least in part, selecting particular bits from the modified NDN, wherein the bits selected are based, at least in part, upon the hashing key.

5. A network device as recited in claim 3, further comprising a broadcaster unit configured to broadcast the DNI and the hashing key.

6. A network device as recited in claim 1, further comprising a monitor unit configured to monitor other DNIs that are broadcast from other networks/domains.

7. A network device as recited in claim 1, further comprising a monitor unit configured to monitor other networks/domains to determine if the other networks/domains are using a DNI matching the DNI produced by the hasher unit.

8. A method comprising:
obtaining a network/domain name (NDN);
eliminating at least a portion of the NDN;
hashing at least the remaining portion of the NDN.

9. A method as recited in claim 8, wherein the eliminating includes removing superfluous data from the NDN, wherein data is superfluous when it is ineffective in helping the NDN distinguish one network/domain from another.

10. A method as recited in claim 8, wherein the eliminating includes removing a group of leading blank or NULL values from the NDN.

11. A method as recited in claim 8, wherein the eliminating includes removing a group of leading non-alphanumeric characters from the NDN.

12. A method as recited in claim 8, wherein the eliminating includes removing most or least significant bit in each byte of the NDN.

13. A method as recited in claim 8, wherein the eliminating includes concatenating the remaining portions of the NDN.

14. A method as recited in claim 8, further comprising broadcasting a hash value resulting from the hashing of the remaining portion of the NDN.

15. A method as recited in claim 8, further comprising selecting a hashing key.

16. A method as recited in claim 15, wherein the hashing produces a domain/network identifier (DNI) based upon the hashing key and the remaining portions of the NDN.

17. A method for facilitating a generation of a distinctive domain name identifier in a network, the method comprising:
obtaining a domain/network identifier (DNI) for identifying a particular domain/network;
monitoring other domains/networks;
determining whether a DNI of another domain/network matches the DNI of the particular domain/network;
in response to the determining, generating a new DNI for identifying the particular domain/network.

18. A method as recited in claim 17, wherein the generating is performed in response to a determination that another domain/network is using a DNI that matches the DNI of the particular domain/network.

19. A method as recited in claim 17, wherein the generating includes:
obtaining the network/domain name (NDN);
eliminating at least a portion of the NDN;
selecting a hashing key;
producing the new DNI by hashing at least the remaining portion of the NDN based upon the hashing key.

20. A method as recited in claim 17, further comprising broadcasting the new DNI and hashing key.
